(19) United States
(12) Patent Application Publication
(10) Pub. No.: US 2010/0082252 A1
(43) Pub. Date: Apr. 1, 2010

(54) DRIVING SUPPORT APPARATUS AND DRIVING SUPPORT SYSTEM FOR MOTOR VEHICLE

(75) Inventor: Nobuyoshi Asanuma, Utsunomiya-shi (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd., Minato-ku, Tokyo (JP)

(21) Appl. No.: 12/597,689

(22) PCT Filed: Feb. 25, 2008
(86) PCT No.: PCT/JP2008/053179

§ 371 Date: Oct. 26, 2009

(30) Foreign Application Priority Data
May 25, 2007 (JP) 2007-139193

(51) Int. Cl. G08G 1/16

(52) U.S. Cl. 701/301

(57) ABSTRACT

This driving support apparatus for a motor vehicle of the present invention includes: a road information storage device for storing road information comprising a plurality of nodes, the road information storage device being mounted in a motor vehicle; a position detection device for detecting position information, including a height, on the motor vehicle from the road information stored in the road information storage device, the position detection device being mounted in the motor vehicle; a communications device capable of exchanging the position information between itself and a communications terminal mounted in a moving object, the communications device being mounted in the motor vehicle; a height difference calculation device for calculating a height difference between the motor vehicle and the moving object from the height of the vehicle detected by the position detection device and the height of the moving object obtained by the communications device, the height difference calculation device being mounted in the motor vehicle; and a control object determination device for determining whether or not to treat the moving object as a control object based on the position information detected by the position detection device and the position information on the moving object obtained by the communications device, the control object determination device being mounted in the motor vehicle. The control object determination device eliminates, from the control object, the moving object with the height difference, calculated by the height difference calculation device, by a predetermined value or more.

### TECHNICAL FIELD

The present invention relates to a driving support apparatus and a driving support system for a motor vehicle.

Priority is claimed on Japanese Patent Application No. 2007-139193, the contents of which are incorporated herein by reference.

### BACKGROUND ART

Driving support apparatuses for a motor vehicle are known that detect the position of a vehicle by receiving a GPS signal and also obtain motor vehicle position information and moving status information on another motor vehicle through vehicle-to-vehicle communication between the motor vehicle and the other motor vehicle, to thereby provide driving support to the motor vehicle at an intersection ahead of the motor vehicle (for example, see Patent Document 1).

Incidentally, aspects where roads intersect each other include a general intersection in which roads intersect each other at the same height and a grade-separated intersection where roads intersect each other at different heights. In the case of a general intersection, another motor vehicle that is moving in the intersectional direction of the road on which the motor vehicle is moving is required to be treated as a decision object when driving support is provided to the motor vehicle. In the case of the grade-separated intersection, even if there is another motor vehicle moving in the intersectional direction of the road on which the motor vehicle is moving, this other motor vehicle is required to be treated as a decision object for driving support. Therefore, it is preferable to eliminate this other motor vehicle from a decision object for driving support.

[Patent Document 1] Japanese Unexamined Patent Application, First Publication No. 2006-24103

### DISCLOSURE OF INVENTION

### Problems to be Solved by the Invention

Conventional methods of determining whether an intersection is grade-separated or not include the followings.

(1) A method based on road information stored in an in-car road information storage portion.
(2) A method based on the latest road information which is updated by learning from the vehicular swept path of the motor vehicle.

However, in the method according to the above (1), an intersection which has been built into a grade-separated intersection with a newly-constructed road will not be determined as a grade-separated intersection so long as the data in the road information storage portion is not updated.

In the method according to the above (2), the movement of the motor vehicle on only one road of a grade-separated intersection will not determine whether there is a height difference between the intersecting roads or not. Therefore, it is not possible to update the road information with information that the road is grade-separated. To update the road information with information that the intersection is grade-separated, it is necessary for the motor vehicle to travel on both of the intersecting roads to verify that there is a height difference between the roads.

Therefore, it is not possible to obtain grade separation information when the motor vehicle passes a grade-separated intersection for the first time.

This sometimes leads to the case where another motor vehicle which is expected to be eliminated from a decision object for the driving support is treated as a decision object.

The present invention has been achieved in view of the above circumstances, and has an object to provide a driving support apparatus and a driving support system for a motor vehicle capable of suitably eliminating another moving object moving or walking on a grade-separated intersection or the like (another motor vehicle or a pedestrian) from a decision object for driving support.

### Means for Solving the Problem

To solve the above problems, the present invention adopts the followings.

(1) A driving support apparatus for a motor vehicle according to the present invention includes: a road information storage device for storing road information comprising a plurality of nodes, the road information storage device being mounted in a motor vehicle; a position detection device for detecting position information, including a height, on the motor vehicle from the road information stored in the road information storage device, the position detection device being mounted in the motor vehicle; a communications device capable of exchanging the position information between itself and a communications terminal mounted in a moving object, the communications device being mounted in the motor vehicle; a height difference calculation device for calculating a height difference between the motor vehicle and the moving object from the height of the vehicle detected by the position detection device and the height of the moving object obtained by the communications device, the height difference calculation device being mounted in the motor vehicle; and a control object determination device for determining whether or not to treat the moving object as a control object based on the position information detected by the position detection device and the position information on the moving object obtained by the communications device, the control object determination device being mounted in the motor vehicle. The control object determination device eliminates, from the control object, the moving object with the height difference, calculated by the height difference calculation device, by a predetermined value or more.

According to the driving support apparatus for a motor vehicle, it is possible to eliminate the moving object with a height difference by a predetermined value or more from a motor vehicle from a decision object of the motor vehicle, to thereby narrow down decision objects for driving support.

(2) The road information storage device may store the height of the vehicle detected by the position detection device or the height of the other moving object obtained by the communications device in accordance with a detection position, and may store a location as a grade-separated intersection if multiple heights are obtained that denote a height difference being greater than or equal to a predetermined value at the location where the roads are determined to intersect each other based on the nodes; and the control determination device may eliminate, from a control object, the moving object that is passing the grade-separated intersection stored in the road information storage device in a intersectional direction of a road on which the motor vehicle is moving.

In this case, it is possible to eliminate, from a decision object for driving support of the motor vehicle, the moving object that is passing a grade-separated intersection in the intersectional direction of the road on which the motor vehicle is moving, to thereby narrow down decision objects for driving support. Furthermore, the grade-separated intersection is stored in the road information storage device. This eliminates the necessity of determining whether or not an intersection is a grade-separated intersection every time the motor vehicle passes the intersection.

(3) Furthermore, a driving support system according to the present invention comprises a fixed station and a driving support apparatus for a motor vehicle, in which the driving support apparatus for a motor vehicle includes: a road information storage device for storing road information constituting a plurality of nodes; a position detection device for detecting position information, including a height, on a motor vehicle from the road information stored in the road information storage device; a communications device capable of exchanging the position information and position information between itself and a communications terminal mounted in a moving object; and a control object determination device for determining whether or not to treat the moving object as a control object based on the position information on the vehicle detected by the position detection device and the position information on the moving object obtained by the communications device. The fixed station includes: a communications device capable of communicating with the driving support apparatus for a motor vehicle; and a grade separation determination device for determining whether or not an intersection is a grade-separated intersection based on plural heights of the other moving objects obtained by the communications device, the fixed station using the communications device to transmit, to the driving support apparatus for a motor vehicle, the position information of a case where the intersection has been determined as a grade-separated intersection by the grade separation determination device. The driving support apparatus for a motor vehicle eliminates, from the control object, the moving object that passes the intersection determined as the grade-separated intersection by the fixed station in a intersectional direction of a road on which the motor vehicle is moving.

According to the above driving support system, the position information on the intersection that has been determined as grade-separated by the fixed station (external information provision equipment) is transmitted to the motor vehicle from the fixed station (external information provision equipment). Therefore, it is possible for the motor vehicle that has obtained the position information to eliminate, from the decision object for driving support of the motor vehicle, the moving object that is passing a grade-separated intersection in the intersectional direction of the road on which the motor vehicle moving, to thereby narrow down decision objects for the driving support.

### EFFECTS OF THE INVENTION

According to the present invention as set forth in the above (1), it is possible to eliminate the moving object with a height difference from the motor vehicle by a predetermined value or more from a decision object of the motor vehicle.

According to the present invention as set forth in the above (2), it is possible to eliminate, from a decision object for driving support of the motor vehicle, another moving object that is passing the grade-separated intersection in the intersectional direction of the road on which the motor vehicle moving, to thereby narrow down decision objects for driving support. Therefore, it is possible to decrease the load required for driving support processing. Furthermore, the grade-separated intersection is stored in the road information storage device of the motor vehicle. This eliminates the necessity of determining whether or not an intersection is a grade-separated intersection every time the motor vehicle passes the intersection. Therefore, it is possible to further decrease the load required for driving support processing.

According to the present invention as set forth in the above (3), it is possible for the motor vehicle that has obtained the position information on the intersection from the fixed station (external information provision equipment) to eliminate, from a decision object for driving support of the motor vehicle, other moving object that is passing a grade-separated intersection in the intersectional direction of the road on which the motor vehicle moving, to thereby narrow down decision objects for the driving support. Therefore, it is possible to decrease the load required for driving support processing.

### BRIEF DESCRIPTION OF THE DRAWINGS

FIG. 1 is a functional block diagram in the case where driving support is provided through vehicle-to-vehicle communication in one embodiment of a motor vehicle driving support apparatus according to the present invention.

FIG. 2 is a functional block diagram in the case where driving support is provided through pedestrian-to-vehicle communication in another embodiment of a motor vehicle driving support apparatus according to the present invention.

FIG. 3 is an explanatory diagram showing the case where another motor vehicle or a pedestrian is treated as a decision object for driving support and a case where it is eliminated from a decision object.

FIG. 4 is a flow chart showing driving support decision object determination processing for another motor vehicle.

FIG. 5 is a flow chart showing driving support decision object determination processing for a pedestrian.

### DESCRIPTION OF THE REFERENCE SYMBOLS

1: motor vehicle driving support apparatus
2: GPS receiver (position detection device)
4: road information storage portion (road information storage device)
5: bidirectional radio (communications device)
6: arithmetic portion (driving support device)
6a: height difference calculation portion (height difference calculation device)
10: portable terminal (communications terminal)
20: base station (external information provision equipment, fixed station)
20a: grade separation determination portion (grade separation determination device)
Vm: motor vehicle (motor vehicle)
Vo, Vo1, Vo2: another motor vehicle

### BEST MODE FOR CARRYING OUT THE INVENTION

Hereunder is a description of one embodiment of a driving support apparatus and driving support system for a motor vehicle according to the present invention, with reference to the drawings.

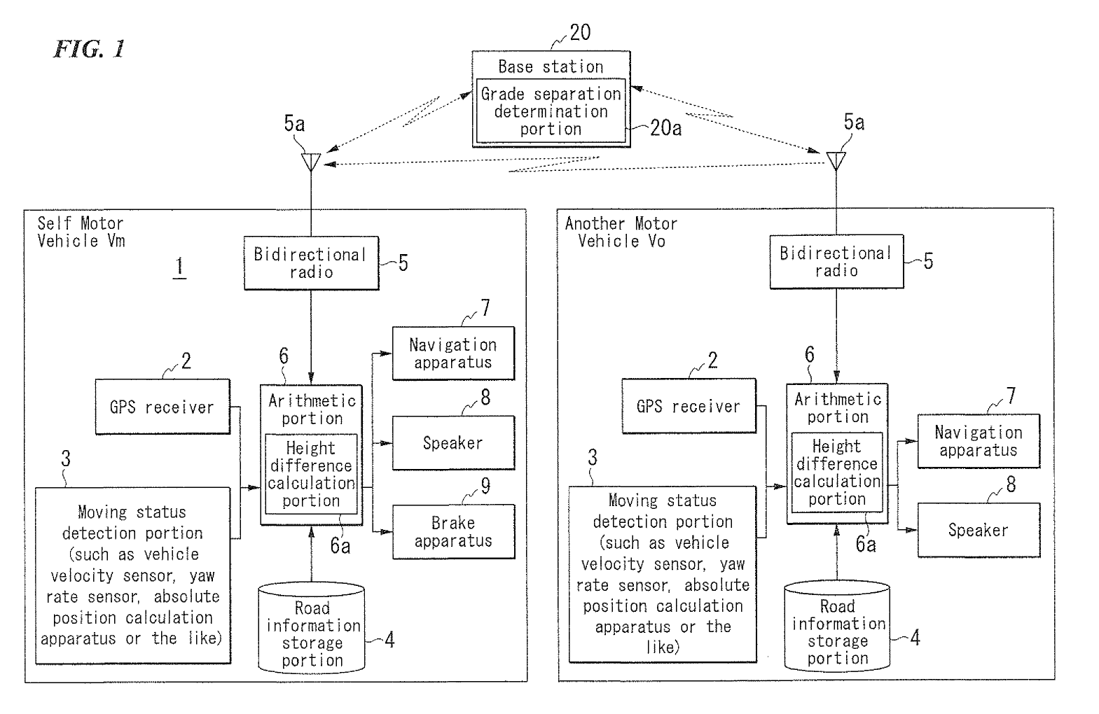

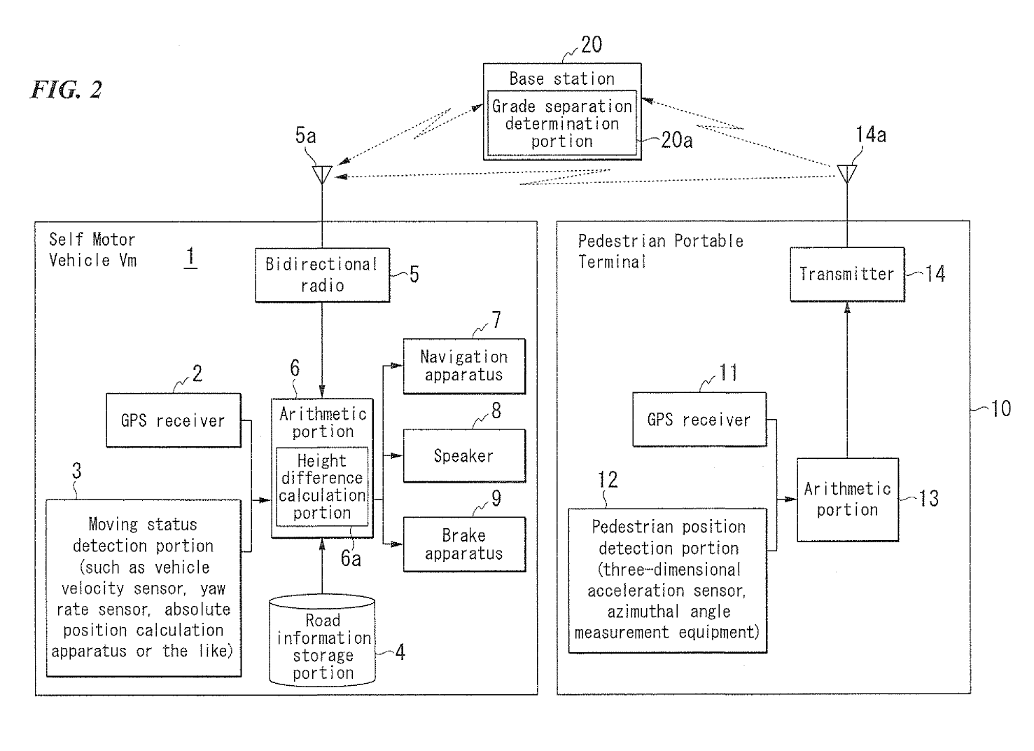

As shown in FIG. 1 and FIG. 2, a motor vehicle (self-motor vehicle) Vm includes a driving support apparatus 1. The driving support apparatus 1 includes: a GPS receiver (position detection device) 2; a moving status detection portion (moving status detection device) 3; a road information storage portion (storage device) 4; a bidirectional radio (communications device) 5; an arithmetic portion (driving support device) 6; a navigation apparatus 7; a speaker (warning device) 8; and a brake apparatus (braking device) 9.

The GPS receiver 2 receives a GPS (Global Positioning System) signal and a positioning signal such as a D (Differential) GPS signal, and then outputs them as current position information on the motor vehicle Vm to the arithmetic portion 6. The GPS signal is for measuring a three-dimensional position information, including a height, on a motor vehicle by utilizing radio waves from a plurality of satellites. The positioning signal is for correcting an error of a GPS signal by utilizing, for example, an appropriate base station, to thereby improve the positioning accuracy.

The moving status detection portion 3 includes sensors for detecting moving status information on the motor vehicle Vm such as: a vehicle velocity sensor for detecting a moving speed (vehicle velocity) of the motor vehicle Vm; a yaw rate sensor for detecting a yaw rate (a rotational angular velocity about the up-down direction axis of the center of gravity of the motor vehicle); a height sensor for detecting an atmospheric pressure; and an absolute position calculation apparatus for appropriately processing outputs of the vehicle velocity sensor, the yaw rate sensor, and the height sensor to calculate absolute position coordinates (X, Y, Z) of the motor vehicle Vm including its height. The moving status detection portion 3 outputs the detected moving status information on the motor vehicle Vm to the arithmetic portion 6.

The road information storage portion 4 stores plural pieces of node information and curve information related to roads as road information. The node information is, for example, data of coordinate points (X, Y, Z) including a height for grasping a road geometry. The curve information constitutes, for example: information related to a starting point and an ending point of a curve that is established on a link (that is, a line connecting the nodes); information related to a curvature of the curve (for example, a curvature, a radius R, and a polarity of the curve); and information related to a depth of the curve (for example, a traverse angle θ required for passing the curve, a length of the curve, and the like).

The road information storage portion 4 updates and stores height information for the nodes based on the position information on another motor vehicle Vo obtained via the bidirectional radio 5. If, from the heights of the nodes, the road is determined to intersect with another road and the height difference at this intersection is determined to be higher than a predetermined value (for example, 5 m or more), the road information storage portion 4 stores the intersection as a grade-separated intersection.

As shown in FIG. 1, the bidirectional radio 5 transmits moving status information on the motor vehicle Vm (for example, the absolute position coordinates, the velocity, the yaw rate, and the like as position information on the motor vehicle Vm) to the other motor vehicle Vo and the base station (external information provision equipment, fixed station) 20 via an antenna 5a, In addition, the bidirectional radio 5 receives moving status information on the other motor vehicle Vo (for example, the absolute position coordinates, the velocity, the yaw rate, and the like as position information on the other motor vehicle Vo) that has been transmitted from the other motor vehicle Vo and the base station 20, and outputs the received moving status information to the arithmetic portion 6.

As shown in FIG. 2, the bidirectional radio 5 is also capable of communicating with a portable terminal (communications terminal) 10 of a pedestrian P. It receives the position information on the pedestrian P that has been transmitted directly from the portable terminal 10 of the pedestrian P or via the base station 20, and outputs the received position information on the pedestrian P to the arithmetic portion 6.

The arithmetic portion 6 includes a CPU (central processing unit). It performs driving support control of the motor vehicle Vm based on the absolute position information on the motor vehicle Vm that has been input from the GPS receiver 2 and the moving status detection portion 3 and based on the moving status information on the other motor vehicle Vo and the position information on the pedestrian P that have been received by the bidirectional radio 5.

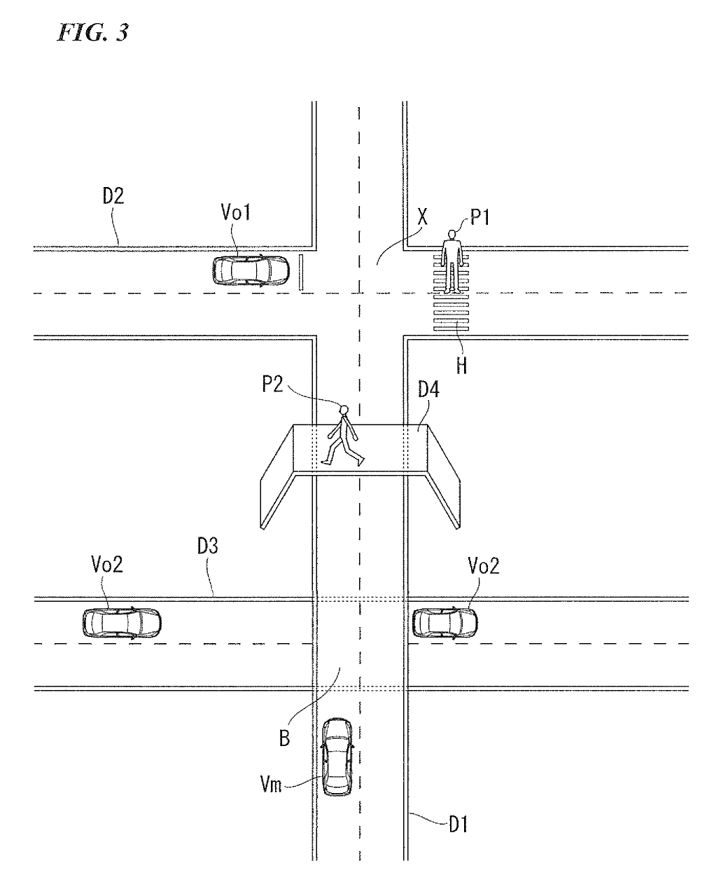

For example, as shown in FIG. 3, there is an intersection X ahead of the motor vehicle Vm on a road D1 on which the motor vehicle Vm is moving (hereinafter, sometimes referred to as a motor vehicle driving road). At the intersection X, the road D1 two-dimensionally intersects with a road D2 (that is, intersects at the same height). If another motor vehicle Vo1 is temporarily stopping on the road D2 in the vicinity of the intersection X or a pedestrian P1 is crossing a crosswalk H of the road D2 in the vicinity of the intersection X, the presence of the other motor vehicle Vo1 or the pedestrian P1 is displayed on the display screen of the navigation apparatus 7 of the motor vehicle Vm to inform the driver of this fact. In the case where the other motor vehicle Vo1 is moving on the road D2 in the direction approaching the intersection X, the brake apparatus 9 of the motor vehicle Vm is used to perform brake assist control, to thereby decelerate the motor vehicle Vin.

The arithmetic portion 6 includes a height difference calculation portion 6a for calculating a height difference between the motor vehicle Vm and the other Vo based on the absolute position information (height) of the motor vehicle Vm and the absolute position information (height) of the other motor vehicle Vo.

The navigation apparatus 7 detects the current position and the direction of movement of the motor vehicle Vm based on the current position information on the motor vehicle Vm that has been input from the GPS receiver 2 and the absolute position coordinates of the motor vehicle Vm that have been detected by the moving status detection portion 3. Based on the detection results, the navigation apparatus 7 performs map-matching on the road information held in the road information storage portion 4, to thereby control the display position of the current position of the motor vehicle Vin on the display screen. At the same time, the navigation apparatus 7 controls a map display on the display screen for the detected current position of the motor vehicle Vm or for an appropriate vehicle position that has been input by the operator via various switches, a keyboard, and the like.

The speaker 8 produces a warning sound or utters a synthesized voice in accordance with a control instruction that is output from the arithmetic portion 6. In the present embodiment, the speaker 8 is used as a warning device.

The brake apparatus 9 actuates a brake actuator of the motor vehicle Vm in accordance with the control instruction that is output from the arithmetic portion 6, to thereby perform brake assist (deceleration support) control.

On the other hand, as shown in FIG. 1, the other motor vehicle Vo includes: a GPS receiver 2; a moving status detection portion 3; a road information storage portion 4; a bidirectional radio 5; an arithmetic portion 6; a navigation apparatus 7; and a speaker 8. The configuration of these is the same as that of the motor vehicle Vm. Therefore, explanation thereof will be omitted.

As shown in FIG. 2, the portable terminal 10 of the pedestrian P includes: a GPS receiver 11; a pedestrian position detection portion 12; an arithmetic portion 13; and a transmitter 14.

The GPS receiver 11 is the same as the GPS receiver 2 of the motor vehicle Vm. Therefore, explanation thereof will be omitted. The pedestrian position detection portion 12 includes, for example: a three-dimensional acceleration sensor; and azimuthal angle measurement equipment (based on geomagnetism or the like). It outputs a detection signal to the arithmetic portion 13.

The arithmetic portion 13 includes a CPU (central processing unit). It calculates a route by use of position information that has been input from the GPS receiver 11 and also by use of an azimuth and a velocity (a result of integration of acceleration) that have been input from the pedestrian position detection portion 12. Then, the arithmetic portion 13 calculates absolute position coordinates of the pedestrian P by the autonomous navigation method.

The transmitter 14 transmits the absolute position information on the pedestrian P calculated by the arithmetic portion 13 to the motor vehicle Vm and the base station 20 via an antenna 14a.

The driving support apparatus 1 performs driving support at the intersection to the motor vehicle Vm, as described above. However, as shown in FIG. 3, if the motor vehicle driving road D1 has an overpass B, and there is a road D3 that three-dimensionally intersects with the motor vehicle driving road D1 under the elevated bridge B (that is, if the motor vehicle driving road D1 is grade-separated from the road D3), it is not necessary to treat another motor vehicle Vo2 present on the road D3 as a decision object for driving support of the motor vehicle Vm.

Furthermore, if there is a walkway D4 such as a footbridge that three-dimensionally intersects with the road D2 ahead of the motor vehicle Vm on the motor vehicle driving road D1, it is not necessary to treat the pedestrian P2 walking on the walkway D4 as a decision object for driving support of the motor vehicle Vm.

Therefore, in the driving support apparatus 1, it is determined whether or not the other motor vehicle Vo or the pedestrian P is to be treated as a decision object for driving support based on the height of the motor vehicle Vm and the height of the other motor vehicle or the pedestrian P.

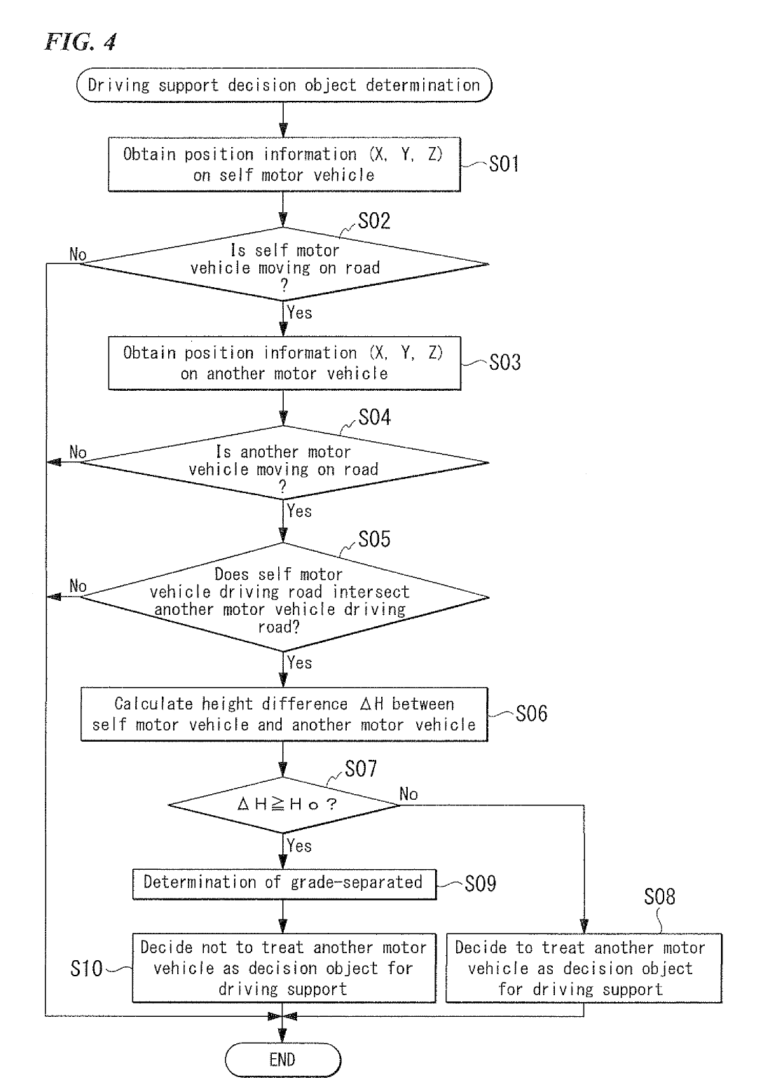

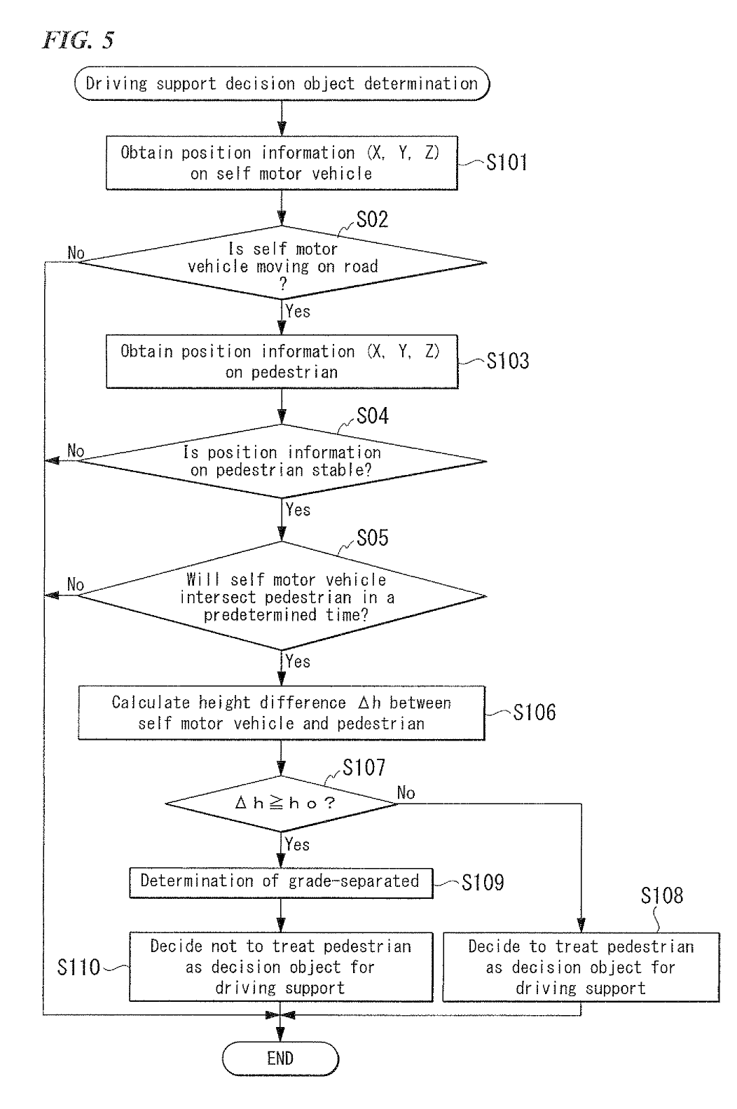

Hereunder is a description of driving support decision object determination processing executed in the arithmetic portion 6 of the driving support apparatus 1 in the motor vehicle Vm, with reference to the flow charts of FIG. 4 and FIG. 5.

First is a description of driving support decision object determination processing for determining whether or not the other motor vehicle Vo is to be treated as a decision object for driving support, with reference to the flow chart of FIG. 4. Note that the driving support decision object determination processing routine of FIG. 4 is repeated at regular time intervals.

At first, in step S01, the current absolute position coordinates (X, Y, Z) of the motor vehicle Vm is read from the moving status detection portion 3 of the motor vehicle Vm or the current position information on the motor vehicle Vm obtained via the UPS receiver 2 is read, to thereby obtain the absolute position, including the height, of the motor vehicle Vm.

Next, the process proceeds to step S02, where it is determined whether or not the motor vehicle Vm is moving on the road corresponding to the road information stored in the road information storage portion 4.

If the determination result in step S02 is “NO” (not moving on the road corresponding to the road information), then the execution of the present routine is terminated.

If the determination in step S02 is “YES” (moving on the road corresponding to the road information), then the process proceeds to step S03, where the position information (absolute position coordinates), including the height, on the other motor vehicle Vo obtained via the bidirectional radio 5 is read.

Next, the process proceeds to step S04, where it is determined whether or not the other motor vehicle Vo is moving on the road corresponding to the road information stored in the road information storage portion 4 of the motor vehicle Vm.

If the determination result in step S04 is “NO” (not moving on the road corresponding to the road information), then the execution of the present routine is terminated.

If the determination result in step S04 is “YES” (moving on the road corresponding to the road information), then the process proceeds to step S05, where it is determined whether or not the motor vehicle driving road and the road on which the other motor vehicle Vo is moving intersect each other based on the road information stored in the road information storage portion 4 of the motor vehicle Vm.

If the determination result in step S05 is “NO” (not intersect each other), then the execution of the present routine is terminated.

If the determination result in step S05 is “YES” (they intersect each other), then the process proceeds to step S06, where a difference AH in height between the motor vehicle Vm and the other motor vehicle Vo is calculated.

Next, the process proceeds to step S07, where it is determined whether or not the height difference ΔH between the motor vehicle Vm and the other motor vehicle Vo is not less than a predetermined value Ho (for example, 5 meters).

If the determination result in step S07 is “NO” (ΔH<Ho), then the process proceeds to step S08, where a decision is made to treat the other motor vehicle Vo as a decision object for driving support. Then, the execution of the present routine is terminated.

If the determination result in step S07 is “YES” (ΔH≧Ho), then the process proceeds to step S09, where the motor vehicle driving road D1 is determined to be grade-separated from the road (D3) on which the other motor vehicle Vo is moving. Subsequently, the process further proceeds to step S10, where a decision is made not to treat the other motor vehicle Vo as a decision object for driving support. Then, the execution of the present routine is terminated.

In this manner, by utilization of vehicle-to-vehicle communication between the motor vehicle Vm and the other motor vehicle Vo, the other motor vehicle Vo2 with a height difference at the intersection from the motor vehicle Vm by a predetermined value or more can be eliminated from a decision object for driving support of the motor vehicle Vm. As a result, it is possible to narrow down other motor vehicles to be treated as a decision object for driving support. Therefore, it is possible to decrease the load required for driving support processing.

It may be configured such that, after the grade separation information on an intersection obtained in this manner is stored in the road information storage portion 4 of the motor vehicle Vm, the other motor vehicle Vo2 that is passing the grade-separated intersection in the intersectional direction of the motor vehicle driving road D1 is determined not to be treated as a decision object for driving support, when the motor vehicle Vm is passing the intersection next time.

In this case, it is possible to omit the processing for calculating a height difference between the motor vehicle Vm and the other motor vehicle Vo to determine whether the intersection is grade-separated or not (steps S06, S07) every time the motor vehicle Vm passes the grade-separated intersection. Furthermore, it is possible to make a decision to eliminate the other motor vehicle Vo1 from a decision object before the actual height difference between the motor vehicle Vm and the other motor vehicle Vo2 becomes the predetermined value Ho or more, in other words, before the motor vehicle Vm reaches the grade-separated intersection.

Furthermore, as shown in FIG. 1, a system may be constructed in which the motor vehicle Vm and the other motor vehicle Vo communicate their respective position information and moving status information via the base station 20. In this case, the motor vehicle Vm can obtain the position information on the other motor vehicle Vo and the like via the base station 20, to thereby perform processing of determining whether or not this another motor vehicle Vo is to be treated as a decision object for the driving support processing in a similar manner as described above.

The base station 20 may include a grade separation determination portion (a grade separation determination device) 20a. The grade separation determination portion 20a stores heights corresponding to the positions of a plurality of vehicles obtained via the bidirectional radios 5 of the motor vehicle Vm and the other motor vehicle Vo. If multiple pieces of information are obtained that denote a height difference being greater than or equal to a predetermined value (for example, 5 m or more) at a location where the roads intersect each other, then the grade separation determination portion 20a determines that the intersection is grade-separated intersection. Then, the base station 20 uses the bidirectional radio 5 to transmit the position information on the intersection, which has been determined to be grade-separated intersection by the grade separation determination portion 20a, to the motor vehicle Vm and the other motor vehicle Vo.

On obtaining the position information on the grade-separated intersection from the base station 20 via the bidirectional radio 5, the motor vehicle Vm makes a decision not to treat the other motor vehicle Vo2 that is passing the grade-separated intersection in the intersectional direction of the motor vehicle driving road D1 as a decision object for driving support. As a result, even at a grade-separated intersection that the motor vehicle Vm passes for the first time, it is possible to obtain grade separation information from the base station 20. This eliminates the necessity for the motor vehicle Vm to determine whether the intersection is grade-separated or not.

In this manner, also by utilization of communication between the motor vehicles and the base station 20, it is possible to eliminate the other motor vehicle Vo2 with a height difference at an intersection from the motor vehicle Vm by a predetermined value or more from a decision object for driving support of the motor vehicle Vm. As a result, it is possible to narrow down other motor vehicles to be treated as decision objects for driving support. Therefore, it is possible to decrease the load required for driving support processing.

In this case, it is possible to made a decision to eliminate the other motor vehicle Vo2 from a decision object before the actual height difference between the motor vehicle Vm and the other motor vehicle Vo2 becomes the predetermined value Ho or more, in other words, before the motor vehicle Vm reaches the grade-separated intersection.

Next is a description of driving support decision object determination processing for determining whether to treat the pedestrian P as a decision object for driving support or not, with reference to the flow chart of FIG. 5. The driving support decision object determination processing routine of FIG. 5 is repeated at regular time intervals.

At first, in step S101, the current absolute position coordinates (X, Y, Z) of the motor vehicle Vm is read from the moving status detection portion 3 of the motor vehicle Vm or the current position information on the motor vehicle Vm obtained via the GPS receiver 2 is read, to thereby obtain the absolute position, including the height, of the motor vehicle Vm.

Next, the process proceeds to step S102, where it is determined whether or not the motor vehicle Vm is moving on the road corresponding to the road information stored in the road information storage portion 4.

If the determination result in step S102 is “NO” (not moving on the road corresponding to the road information), then the execution of the present routine is terminated.

If the determination in step S102 is “YES” (moving on the road corresponding to the road information), then the process proceeds to step S103, where the position information (absolute position coordinates), including the height, of a pedestrian P present within the communication area obtained via the bidirectional radio 5 is read.

Next, the process proceeds to step S104, where it is determined whether or not the absolute position coordinates of the pedestrian P is stable.

If the determination result in step S104 is “NO” (unstable), then the execution of the present routine is terminated.

If the determination result in step S104 is “YES” (stable), then the process proceeds to step S105, where it is determined whether or not the motor vehicle Vm will intersect the pedestrian P in a predetermined time in the case where the motor vehicle Vm keeps on moving with the current velocity retained.

If the determination result in step S105 is “NO” (will not intersect), then the execution of the present routine is terminated.

If the determination result in step S105 is “YES” (will intersect), then the process proceeds to step S106, where a difference Δh in height between the motor vehicle Vm and the pedestrian P is calculated.

Next, the process proceeds to step S107, where it is determined whether or not the height difference Δh between the motor vehicle Vm and the pedestrian P is a predetermined value ho or more (for example, 5 meters or more).

If the determination result in step S07 is “NO” (Δh<ho), then the process proceeds to step S108, where a decision is made to treat the pedestrian P as a decision object for driving support. Then the execution of the present routine is terminated.

If the determination result in step S107 is “YES” (Δh≧ho), then the process proceeds to step S109, where a pedestrian P2 is determined to be on the walkway B that is grade-separated from the motor vehicle driving road D1. Subsequently, the process further proceeds to step S110, where a decision is made not to treat the pedestrian P2 as a decision object for driving support. Then, the execution of the present routine is terminated.

As a result, by utilization of pedestrian-to-vehicle communication between the pedestrian P and the motor vehicle Vm, the pedestrian P2 with a height difference from the motor vehicle Vm by a predetermined value or more can be eliminated from a decision object for driving support of the motor vehicle Vm. As a result, it is possible to narrow down pedestrians to be treated as the decision objects for driving support. Therefore, it is possible to decrease the load required for driving support processing.

It may be configured such that, after the grade separation information on the walkway D4 obtained in this manner is stored in the road information storage portion 4 of the motor vehicle Vm, the pedestrian P who is walking in the vicinity of the grade-separated intersection is determined not to be treated as a decision object for driving support, when the motor vehicle Vm is passing the intersection next time.

In this case, it is possible to omit the processing for calculating a height difference between the motor vehicle Vm and the pedestrian P to determine whether the intersection is grade-separated or not (steps S106, S107) every time the motor vehicle Vm passes the grade-separated intersection. Furthermore, it is possible to make a decision to eliminate the pedestrian P from the decision object before the actual height difference between the motor vehicle Vm and the pedestrian P becomes the predetermined value ho or more, in other words, before the motor vehicle Vm reaches a point under the walkway D4.

Furthermore, as shown in FIG. 2, a system may be constructed in which the pedestrian P communicates its position information to the motor vehicle Vm via the base station 20. In this case, the motor vehicle Vm obtains the position information on the pedestrian P via the base station 20, to thereby perform processing of determining whether or not the pedestrian P is to be treated as a decision object for the driving support processing in a similar manner as described above.

The present invention is not limited to the above embodiments.

For example, the base station (external information provision equipment) 20 may be a road infrastructure facility or a server on the Internet.

### INDUSTRIAL APPLICABILITY

According to the present embodiment, it is possible to provide a driving support apparatus and a driving support system for a motor vehicle capable of suitably eliminating other motor vehicle or a pedestrian moving or walking on a grade-separated intersection or the like from a decision object for driving support.

1. A driving support apparatus for a motor vehicle, comprising:
a road information storage device for storing road information comprising a plurality of nodes, the road information storage device being mounted in a motor vehicle;
a position detection device for detecting position information, including a height, on the motor vehicle from the road information stored in the road information storage device, the position detection device being mounted in the motor vehicle;
a communications device capable of exchanging the position information between itself and a communications terminal mounted in a moving object, the communications device being mounted in the motor vehicle;
a height difference calculation device for calculating a height difference between the motor vehicle and the moving object from the height of the vehicle detected by the position detection device and the height of the moving object obtained by the communications device, the height difference calculation device being mounted in the motor vehicle; and
a control object determination device for determining whether or not to treat the moving object as a control object based on the position information detected by the position detection device and the position information on the moving object obtained by the communications device, the control object determination device being mounted in the motor vehicle, wherein:
the control object determination device eliminate, from the control object, the moving object with the height difference, calculated by the height difference calculation device, from the motor vehicle by a predetermined value or more.

2. The driving support apparatus for a motor vehicle according to claim 1, wherein
the road information storage device stores the height of the vehicle detected by the position detection device or the height of the other moving object obtained by the communications device in accordance with a detection position, and stores a location as a grade-separated intersection if multiple heights are obtained that denote a height difference being greater than or equal to a predetermined value at the location where the roads are determined to intersect each other based on the nodes; and
the control determination device eliminate, from a control object, the moving object that is passing the grade-separated intersection stored in the road information storage device in a intersectional direction of a road on which the motor vehicle is moving.

3. A driving support system comprising a fixed station and a driving support apparatus for a motor vehicle,
wherein the driving support apparatus for a motor vehicle includes:
a road information storage device for storing road information comprising a plurality of nodes;
a position detection device for detecting position information, including a height, on a motor vehicle from the road information stored in the road information storage device;
a communications device capable of exchanging the position information between itself and a communications terminal mounted in a moving object; and
a control object determination device for determining whether or not to treat the moving object as a control object based on the position information on the vehicle detected by the position detection device and the position information on the moving object obtained by the communications device, and
wherein the fixed station includes: a communications device capable of communicating with the driving support apparatus for a motor vehicle; and a grade separation determination device for determining whether or not an intersection is a grade-separated intersection based on plural heights of the moving objects obtained by the communications device,
the fixed station using the communications device to transmit, to the driving support apparatus for a motor vehicle, the position information of a case where the intersection has been determined as a grade-separated intersection by the grade separation determination device; and
the driving support apparatus for a motor vehicle eliminating, from the control object, the moving object that passes the intersection determined as the grade-separated intersection by the fixed station in a intersectional direction of a road on which the motor vehicle is moving.
